(19) United States
(12) Patent Application Publication
(10) Pub. No.: US 2013/0006688 A1
(43) Pub. Date: Jan. 3, 2013

(54) CREATING A 3RD PARTY TEAM PROJECT STORY BOARD

(75) Inventor: Adam Knapp, Mesa, AZ (US)

(73) Assignee: THE GO DADDY GROUP, INC., Scottsdale, AZ (US)

(21) Appl. No.: 13/175,763

(22) Filed: Jul. 1, 2011

(51) Int. Cl. G06Q 10/00

(52) U.S. Cl. 705/7.15; 705/7.17

(57) ABSTRACT

Systems and methods provide for hosting one or more server computers comprising a project management software. The project management software may comprise a first story board comprising one or more stories for a first team. The first story board may be controlled by one or more first story board control panels. The project management software may also comprise a second story board comprising one or more stories for a second team. A sub-story may be created using the one or more first story board control panels. In one embodiment, this sub-story may be inserted into a backlog list for the second story board and an alert may be displayed on the second story board requesting the second team to implement the sub-story from the backlog list into the second story board. In another embodiment, the stories on the second story board may be about, but not used by, a second team. The first team may be responsible for updating the one or more stories to move the one or more stories, including the sub-story, through the second story board.

### CROSS REFERENCE TO RELATED PATENT APPLICATIONS

This patent application is related to the following concurrently-filed patent applications:

U.S. patent application Ser. No. ______, “CREATING A SUB-STORY FOR A PROJECT STORY BOARD.”

U.S. patent application Ser. No. ______, “PROJECT STORY BOARD TO BOARD COMMUNICATION TOOLS.”

The subject matter of all patent applications is commonly owned and assigned to The Go Daddy Group, Inc. All prior applications are incorporated herein in their entirety by reference

### FIELD OF THE INVENTION

The present inventions generally relate to the field of project management and specifically to the field of creating and communicating between multiple Kanban project management story boards.

### SUMMARY OF THE INVENTION

The present inventions provide methods and systems for. An exemplary method may comprise several steps including the steps of hosting one or more server computers comprising a project management software. The one or more server computers may be communicatively coupled to a network. The project management software may comprise a first story board comprising one or more stories for a first team. The first story board may be controlled by one or more first story board control panels. The project management software may also comprise a second story board comprising one or more stories for a second team. A sub-story may be created using the one or more first story board control panels, and this sub-story may be inserted into a backlog list for the second story board. An alert may then be displayed on the second story board requesting the second team to implement the sub-story from the backlog list into the second story board.

The present inventions also provide methods and systems for hosting one or more server computers comprising a project management software. The one or more server computers may be communicatively coupled to a network. The project management software may comprise a story board comprising one or more stories for a first team. The first story board may be controlled by one or more first story board control panels. The project management software may also comprise a second story board comprising one or more stories about, but not used by, a second team. A sub-story may be created using the one or more first story board control panels, and this sub-story may be inserted into the second story board. The first team may be responsible for updating the one or more stories to move the one or more stories, including the sub-story, through the second story board.

The above features and advantages of the present inventions will be better understood from the following detailed description taken in conjunction with the accompanying drawings.

### BRIEF DESCRIPTION OF THE DRAWINGS

FIG. 1 is a flow diagram illustrating a possible embodiment of a method for creating one or more stories and sub-stories for a project management story board.

FIG. 2 illustrates a possible system for creating one or more stories and sub-stories for a project management story board.

FIG. 3 is a flow diagram illustrating a possible embodiment of a method for creating one or more stories and sub-stories for a project management story board.

FIG. 4 illustrates a possible embodiment of an interface for creating one or more stories and sub-stories for a project management story board.

FIG. 5 is a flow diagram illustrating a possible embodiment of a method for creating one or more stories and sub-stories for a project management story board.

FIG. 6 illustrates a possible embodiment of an interface for creating one or more stories and sub-stories for a project management story board.

FIG. 7 is a flow diagram illustrating a possible embodiment of a method for creating one or more stories and sub-stories for a project management story board.

FIG. 8 illustrates a possible embodiment of an interface for creating one or more stories and sub-stories for a project management story board.

FIG. 9 is a flow diagram illustrating a possible embodiment of a method for creating one or more stories and sub-stories for a project management story board.

FIG. 10 illustrates a possible embodiment of an interface for creating one or more stories and sub-stories for a project management story board.

FIG. 11 is a flow diagram illustrating a possible embodiment of a method for creating one or more stories and sub-stories for a project management story board.

FIG. 12 is a flow diagram illustrating a possible embodiment of a method for creating one or more stories and sub-stories for a project management story board.

FIG. 13 is a flow diagram illustrating a possible embodiment of a method for creating one or more stories and sub-stories for a project management story board.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

The Kanban project management method is defined by a set of key principles and practices. Five of these core principles include: 1. Visualize the Workflow: Represent the work items and the workflow on a card wall or electronic board; 2. Limit Work-in-Progress (WIP): Set agreed upon limits to how many work items are in progress at a time; 3. Measure & Manage Flow: Track work items to see if they are proceeding at a steady, even pace; 4. Make Process Policies Explicit: Agree upon and post policies about how work will be handled; and 5. Use Models to Evaluate Improvement Opportunities: Adapt the process using ideas from Systems Thinking.

The Kanban project management method also employs a “recipe of success” including 1. Focus on Quality 2. Reduce Work-in-Progress 3. Deliver Often 4. Balance Demand Against Throughput 5. Prioritize 6. Attack Sources of Variability to Improve Predictability. By using these techniques, benefits are achieved for both the customer and the employees.

Software organizations may use these Kanban principles for software development to be predictable or to accurately state what work will be done and when it will be finished. The Kanban method may allow mechanisms to be in place to determine prioritization, workflow and lead time to delivery. This method may also be used to give more precise direction on how to invest development energy into only the most valuable work. The end result may be a development pipeline that predictably and efficiently delivers high value work.

In a software application development and project management context, Kanban's focus on quality using professional testers, test driven development utilizing unit tests, automating regression testing, code inspections, peer review, collaborative analysis design, reducing quantity of design-in-progress may boost software quality.

Conceptualizing the Project

The life cycle of the business process may include creating or receiving a raw request. A raw request may be a request for work from a stakeholder in the organization. The project management system disclosed herein may provide a plurality of different access rights for these stakeholders and other users of the project management system. A “user” may be a standard user of the system who may create, edit and/or move “stories” for every product the stories are associated with. A user may view any section of the system described herein. A “product manager” may have the same rights as the user, but may also create and manage milestones and/or releases for every product and/or team they are associated with. A “business analyst” may only have rights to manipulate the elaboration board and/or project tree (discussed in greater detail herein) for products and/or teams they are associated with. A “project manager” may have the same rights as a business analyst and a product manager.

Moving from a raw request to a milestone/release may include two phases: an elaboration phase and an implementation phase, each with a set of work items or “stories,” and the workflow for the stories on a card wall or electronic board. A raw request may simply be a story that lives on the board for the elaboration phase, or “elaboration board.” The elaboration may be related to the “planning board” and/or “project tree” described below. The only way to create a raw request may be to have user access rights to the elaboration board.

The elaboration phase may consist of meetings including business analysts, project managers, and product managers. During the meetings, the raw request may be turned into a project. The request backlog, which consists of all items and requests from stakeholders waiting to be examined, may be analyzed to allow project managers or business analysts for a product to pick a request from the request backlog as next up for elaboration.

The project may then be schedule split into one or more project milestones which schedule one or more Minimal Marketable Features (MMFs). The project may be decomposed into one or more MMFs. The MMFs are then decomposed into one or more user stories, which make up one or more milestones and/or releases. “Starter” user stories may also be created and added to the board during this phase which may help kick-start the implementation phase. The story (raw request) may then either be put into a backlog for the elaboration/planning board, where a raw request may become a project, or may be put on the actual elaboration board itself in a “next up” column. Once the story/raw request is in the next up column, the elaboration process, which consists of all the story boards for each product, can begin. This phase may be made up of user stories and milestones and/or releases.

In summary, a project may be a container for one or more user stories, one or more project milestones and/or one or more stand-alone MMFs and may be part of the elaboration phase. A project milestone may be part of the elaboration phase and may be used to help schedule phases of a project. A project milestone may also schedule a group of MMFs. An MMF may be the smallest decomposition that is still meaningful as a business release (in other words, an implementation-ready batch) and may be part of the elaboration phase. An MMF may be decomposed into, or made up of, one or more user stories, which may be a part of the implementation phase. A user story may be considered a work item that makes up a team's work in progress. A milestone/release may consist of one or more user stories and is a part of the implementation phase.

Methods and Systems for Creating a Project Tree

Several different methods may be used to provide and manage the disclosed inventions. In an example embodiment described herein, any combination of software modules used together with hardware on one or more server computers and/or client computers, described below, may create a project tree. The project tree may be any graphical user interface, described below, using a tree structure and graphical user interface elements as are known in the art, comprising a table of the information described within this section.

The project tree may allow users to control the elaboration phase. There are two main goals the project tree may aim to accomplish. First, the project tree may give a holistic view into actual work-in-progress and committed projects. Second, the project tree may be completely transparent to all users of the disclosed system. The tree may be broken down within each branch of the tree and/or each row of the table by year, quarter, driving/owning product (the product that is the ‘owner’ of a project), project, project milestone, MMF and associated team (a team that has the power to associate a user story to the MMF, and is required to complete an MMF).

In order to create a project, a project milestone, an MMF, or an association between a team and an MMF, the user may be required to have the user rights of a business analyst or a project manager. To create a project, an appropriate icon on the project tree page may be selected by a user to enter an “edit mode” to add a project. A popup window may then be used to enter the appropriate information regarding the project. The project may require an association with a raw request, possibly displayed for raw requests that are in-progress or complete on the board. Non-limiting examples of information entered into fields within the popup window may include a text field for a project name, a dropdown field for a project owner, a dropdown field for a raw request and a text field for a target date.

In order to create a project milestone, an MMF, an association between a team and an MMF, or a project may need to be created. After the project has been created actions may be performed on the project. These actions may be performed in an “edit mode,” possibly using an “actions column” associated with the project. As a non-limiting example, a series of dropdown menus or clickable icons, as are known in the art, may be used to perform these actions within the actions column. These dropdowns may then be used to create a project, a project milestone or an MMF at the appropriate level. A project may also be deleted using similar user interface inputs if the project is empty or may be archived if it is 100% complete.

To provide a full holistic view between work-in-progress (implementation) and projects (elaboration), the creation of an association between a team and an MMF may tie the two together: In edit mode, a team may be selected, possibly using a dropdown or clickable icon described above. Once the team is selected, another user interface tool, possibly a plus sign, dropdown and/or clickable icon may be selected to add the team to be associated to the MMF. Any team added may then be able to see the MMF available in each user story and associate any story to an MMF.

Progress may be tracked within the project tree for each team associated with an MMF, the MMFs themselves, project milestone and projects. As a non-limiting example, a progress percentage may be displayed in a column on the project tree for each of the teams, MMFs, project milestones and projects, which may indicate how close to completion a specific piece of the project is.

Each piece of the project may be weighted equally. As a non-limiting example, if there are two teams associated with an MMF, each may consist of 50% of the MMF. The same principle may be applied to project milestones. For example, if there are 3 MMFs for a project milestone, each MMF may have a 33.3% weight. This may continue all the way up the chain to the project level of the project tree, the assumption being that the project is only as strong as its weakest link.

An icon or link within the project table at the team level may also be clicked on to see what stories a team has associated with an MMF. A list of stories may be displayed, including any blocked stories (discussed in more detail herein) associated with the MMF.

Once the projects, project milestones or MMFs have been completed, each associated product/team may still see the MMFs as available to select in their user stories. In order to stop displaying the MMF as an option in each user story, an integrated archive feature may be used. In order to archive a project, project milestone or MMF, a user with business analyst or a project manager rights may archive any component once it has been 100% complete. The option to archive may be displayed as a dropdown field, clickable icon, link, etc. Once a piece of the project has been archived, it may also be un-archived, which, in turn, may expose the underlying MMFs to the teams and products again.

Methods and Systems for Creating a Story on a Story Board

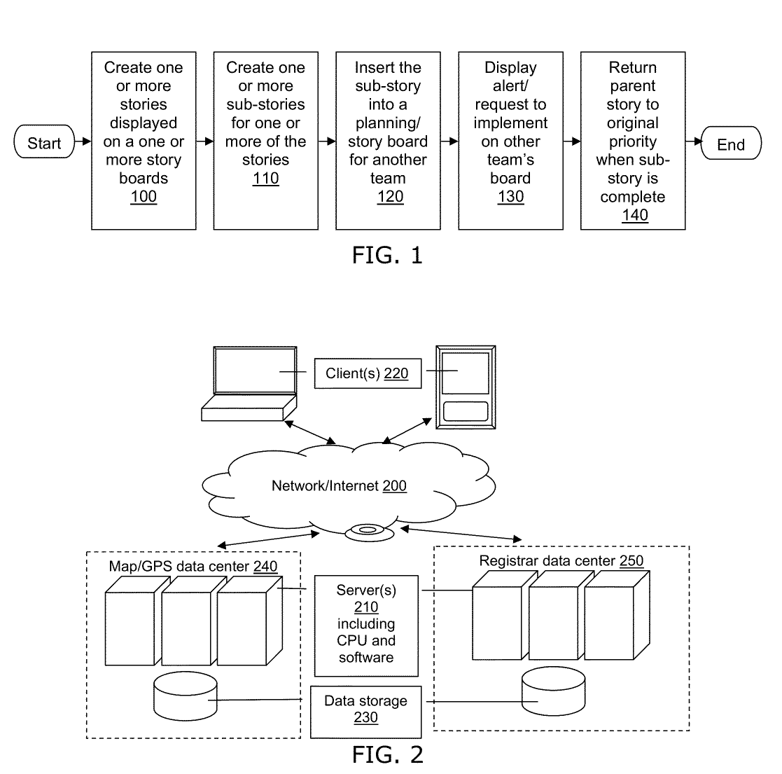

Several different methods may be used to provide and manage the disclosed inventions. In an example embodiment illustrated in FIG. 1, any combination of software modules used together with hardware on one or more server computers and/or client computers, described below, may be used to create one or more stories on a story board (Step 100).

Several different environments may be used to accomplish the steps of embodiments disclosed herein. FIG. 2 demonstrates a streamlined example of such an environment and illustrates a non-limiting example of a system and/or structure that may be used to accomplish the methods and embodiments disclosed and described herein. Such methods may be performed by any central processing unit (CPU) in any computing system, such as a microprocessor running on at least one server 210 and/or client 220, and executing instructions stored (perhaps as scripts and/or software, possibly as software modules) in computer-readable media accessible to the CPU, such as a hard disk drive on a server 210 and/or client 220.

The example embodiments herein place no limitations on whom or what may comprise users. Thus, as non-limiting examples, users may comprise any individual, entity, business, corporation, partnership, organization, governmental entity, and/or educational institution that may have occasion to seek information for management of software or other projects.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The server(s) 210 and client(s) 220 (along with software modules and the data storage 230 disclosed herein) may be communicatively coupled to the network 200 and to each other in such a way as to allow the exchange of information required to accomplish the method steps disclosed herein, including, but not limited to receiving the information from a user interface on one or more clients 220, and one or more servers 210 receiving the information.

The client 220 may be any computer or program that provides services to other computers, programs, or users either in the same computer or over a computer network 200. As non-limiting examples, the client 220 may be an application, communication, mail, database, proxy, fax, file, media, web, peer-to-peer, or standalone computer, cell phone, “smart” phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex, Silverlight, any programming environments for mobile “apps,” or any combination thereof.

The client computer(s) 220 which may be operated by one or more users and may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, a “smart” phone, an Internet access device, a rich client, thin client, or any other client functional with a client/server computing architecture. Client software may be used for authenticated remote access to one more hosting computers or servers, described below. These may be, but are not limited to being accessed by a remote desktop program and/or a web browser, as are known in the art.

The user interface displayed on the client(s) 220 and/or the server(s) 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in and after FIG. 4, including Touch interfaces, Conversational Interface Agents, Live User Interfaces (LUI), Command line interfaces, Non-command user interfaces, Object-oriented User Interfaces (OOUI) or Voice user interfaces. Any information generated by the user, or any other information, may be accepted using any field, widget and/or control used in such interfaces, including but not limited to a text-box, text field, button, hyper-link, list, drop-down list, check-box, radio button, data grid, icon, graphical image, embedded link, etc.

The software modules used in the context of the current invention may be stored in the memory of—and run on—at least one server 210 and/or client 220. The software modules may comprise software and/or scripts containing instructions that, when executed by a microprocessor on a server 210 and/or client 220, cause the microprocessor to accomplish the purpose of the module or the methods disclosed herein.

The software modules may interact and/or exchange information via an Application Programming Interface or API. An API may be a software-to-software interface that specifies the protocol defining how independent computer programs interact or communicate with each other. The API may allow a requesting party's software to communicate and interact with the software application and/or its provider—perhaps over a network—through a series of function calls (requests for services). It may comprise an interface provided by the software application and/or its provider to support function calls made of the software application by other computer programs, perhaps those utilized by the requesting party to provide information for publishing or posting domain name and hosted website information.

The API may comprise any API type known in the art or developed in the future including, but not limited to, request-style, Berkeley Sockets, Transport Layer Interface (TLI), Representational State Transfer (REST), SOAP, Remote Procedure Calls (RPC), Standard Query Language (SQL), file transfer, message delivery, and/or any combination thereof.

The software modules may also include mobile applications, possibly on a client computer and/or mobile device. These mobile applications, or “apps” may comprise computer software designed to help people perform an activity and designed to help the user to perform singular or multiple related specific tasks. It helps to solve problems in the real world by manipulating text, numbers, graphics, or a combination of these elements.

The server(s) utilized within the disclosed system 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof).

The server 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The server(s) 210 or software modules within the server(s) 210 may use query languages such as MSSQL or MySQL to retrieve the content from data storage 230. Server-side scripting languages such as ASP, PHP, CGI/Perl, proprietary scripting software/modules/components etc. may be used to process the retrieved data. The retrieved data may be analyzed in order to determine information recognized by the scripting language, information to be matched to those found in data storage, availability of requested information, comparisons to information displayed and input/selected from the user interface or any other content retrieval within the method steps disclosed herein.

The server 210 and/or client 220 may be communicatively coupled to data storage 230 to retrieve any information requested. The data storage 230 may be any computer components, devices, and/or recording media that may retain digital data used for computing for some interval of time. The storage may be capable of retaining stored content for any data requested, on a single machine or in a cluster of computers over the network 200, in separate memory areas of the same machine such as different hard drives, or in separate partitions within the same hard drive, such as a database partition.

Non-limiting examples of the data storage 230 may include, but are not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

As seen in FIG. 2, the server(s) 210 and data storage 230 may exist and/or be hosted in one or more data centers (240, 250). These data centers 240/250 may provide hosting services for websites, services or software relating to stored information, or any related hosted website including, but not limited to hosting one or more computers or servers in a data center 240/250 as well as providing the general infrastructure necessary to offer hosting services to Internet users including hardware, software, Internet web sites, hosting servers, and electronic communication means necessary to connect multiple computers and/or servers to the Internet or any other network 200. These data centers 240/250 or the related clients 220 may accept messages from text messages, SMS, web, mobile web, instant message, third party API projects or other third party applications.

As users access and/or input information, this information may be redirected and distributed between and among the data centers (240, 250) via commands from any combination of software modules hosted on the server(s) 210 and executed via processors on the server(s) 210. This information may then be accessed and manipulated by the combination of software modules or stored in the data storage 230 of any of a plurality of data centers, either separate from or integrated into the one or more servers, so that the information is available to be searched and accessed by the user and/or any other components of any or all data centers.

Any references to “software combination,” “combination of software,” “combination of software modules” etc. referred to herein may include any combination of software modules executed by a microprocessor on either the server 210 or client 220 computers. These software modules may also be used in combination with any other hardware or software structures disclosed herein. The servers 210 may be hosted in any data center (240, 250) operated by any hosting provider such as those disclosed herein and the servers 210 and clients 220 may be operated by any users disclosed herein.

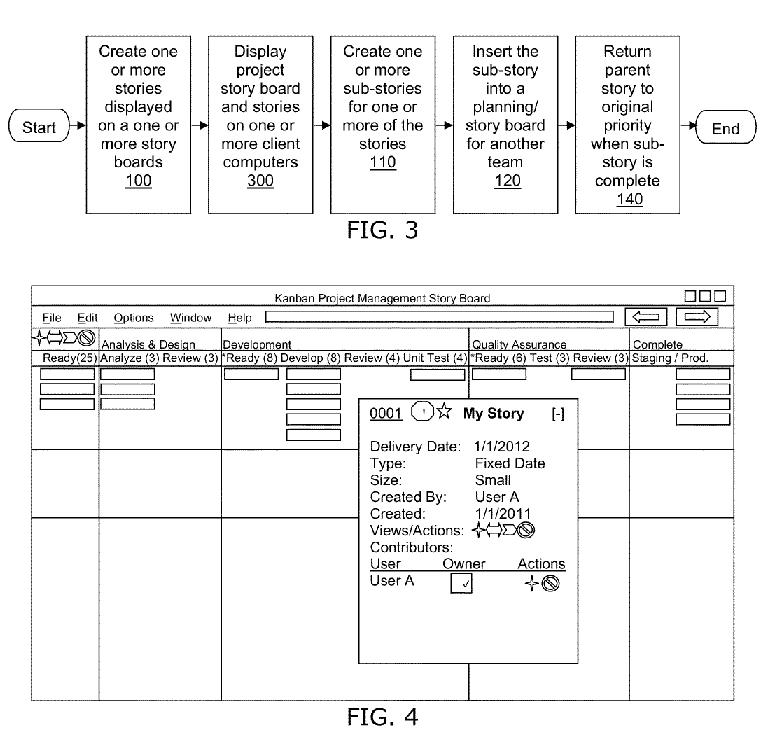

FIG. 3 shows that the embodiments illustrated in FIGS. 1-2, as well as other disclosed embodiments, may include the step of displaying a project management storyboard on the one or more client computers (Step 300).

FIG. 4 shows an example interface using the disclosed structure and software modules that may be used to display a project management storyboard on the one or more client computers (Step 300). The purpose of the story board may be to take an existing software development process and bring it into sharper focus. The board may reveal details about the current software development or other process providing visibility that may allow the organization to better understand and better communicate about needed changes. A story board may bring greater visibility into what work is being done and the issues that arise with work items or the workflow. Understanding the current capability of the system of development may give more accurate predictability.

The story board may be divided into one or more columns. Columns on the board may represent the activities performed, in the order first performed. The non-limiting example interface in FIG. 4 includes columns for analysis and design, development, quality assurance and complete projects. A common use case in a Kanban management system may be to split work that is in-progress and completed in different columns. Each of these columns in this example may be further subdivided into columns such as ready, analyze, review, develop, unit test, test, staging, production, or any combination thereof. A buffer or queue between activities may also be used, seen by an asterisk in the example in FIG. 4. The columns may also include an indicator for limits on work-in-progress (WIP), represented in this example by numbers in parentheses.

A limit on WIP may be used to constrain how many work items may be in each workflow step at a time. When a work item progresses, a slot may open and a new work item may flow into the development step. A key result of a WIP limit is that blocked work “holds up the line.” A blocked work item may still count against the limit, so a situation may arise in which no new work can progress until the block is resolved, and emphasizes the value of “blocking” sub-stories described below. This blocked work may drive collaboration as the team is highly motivated to clear the blockage. Limits may be in the range of one to three items per person, pair or team. WIP limits may be agreed upon through consensus with up and downstream stakeholders and senior function management as well as the development team.

A report may be generated by the current system including a cumulative-flow diagram used to show quantities of WIP at each stage in the system. If the Kanban system is flowing correctly, the bands on any related report or related chart should be smooth and their height should be stable. Drill down options may be displayed within the report, possibly as dropdown fields, allowing a user to view quantities of WIP including ready, in progress, complete (general status overview of the stories), main columns (breaks the stories down further into header column that they were in at the end of the specified interval) and all columns (breaks the stories down into the actual column that they were in at the end of the specified interval).

The story board may include a filter view, where the user may have options to filter the stories that are displayed on the story board. As a non-limiting example, a user may view all of the stories that they are contributing on, have been assigned to, or are watching. The filter view may include a “my stories” view, a “team member” view and a “milestone” view, related to concepts discussed in more detail herein. The team member view may include stories assigned or unassigned to contributors on a given team. Stories may also be associated with a given milestone that hasn't been archived. Each story may be marked with an icon as a friendly reminder when a filter is on for viewing that story. Although icons, dropdowns, checkboxes and other graphical user interface controls are specifically shown in FIGS. 4-10, these should not limit the graphical user interface controls that can be used to accomplish these method steps.

As a non-limiting example, the filter view may also include a dropdown (not shown) displayed on the story board interface and designed to display the story board according to various factors selected by the user. These factors may include teams, project milestones, MMFs, or milestones. If the user is not a member of the creating team for the stories, the user will only be able to view the teams, MMFs, project milestones, projects and/or milestones for those stories.

The current stories being displayed on the story board view may also be adjusted. As seen in the top left corner of the storyboard in FIG. 4, a group of icons may be displayed for adjusting the display of the current stories on the story board. As non-limiting examples, the columns on the board may be collapsed or expanded. The milestones associated with certain stories may be distinguished by “swim lanes” (represented in FIG. 4 by horizontal lines dividing the story board) for those milestones, which may be viewed or hidden. The stories themselves may include a card view or list view. In FIG. 4, the majority of the stories are in list view. One story has been expanded to card view for example purposes.

When an uncompleted story's delivery date has expired, an alert icon may be tagged on the story to help visualize the delay (not shown). Likewise, each story may be tagged with an icon to help visualize the delay if it has not moved from the same column for a week, 2 weeks, or 3 weeks. The icons for the tags/icons may be color-coded to visualize the length of time in any given column, or if the story's delivery date has expired. As a non-limiting example, a story with an expired delivery date may have a red tag/icon, a story that has not moved from the same column for a week may have blue tag/icon, a story that has not moved from the same column for 2 weeks may have a yellow icon and a story that has not moved from the same column for 3 weeks may have an orange tag/icon. By hovering over the tag/icon, additional details may be displayed regarding the delay or expired delivery date.

Another way to visualize a delay may be through a story flow dashboard, possibly displayed to a user after logging on to the disclosed system using proper authentication. The story flow dashboard may display a view into how well stories are flowing on a story board that are in ‘Ready’ or ‘In-Progress’ columns. This story flow dashboard may display if stories are flowing, haven't moved in 1, 2, or 3 weeks, or are blocked.

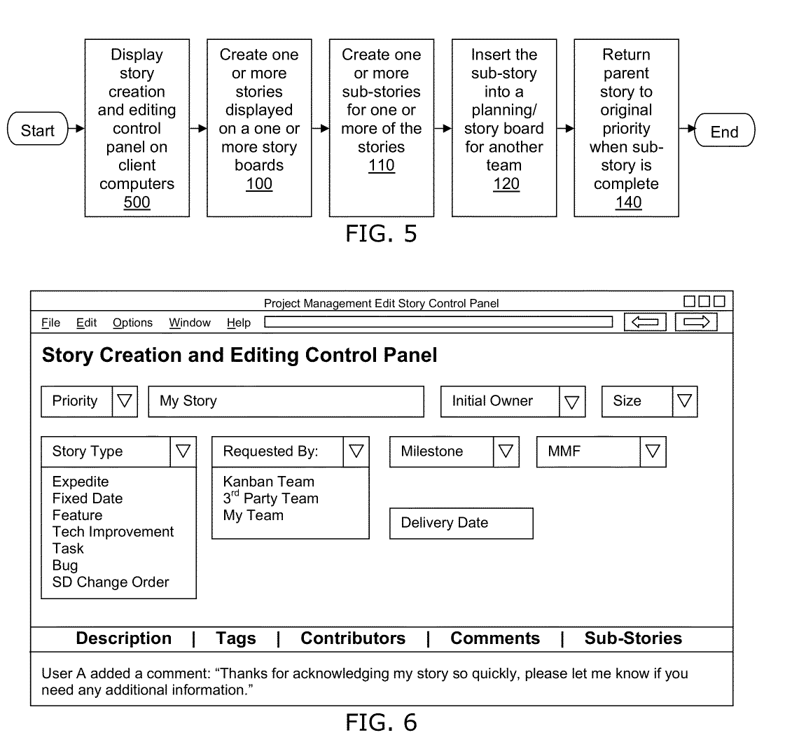

FIG. 5 shows that the embodiments illustrated in FIGS. 1-4, as well as other disclosed embodiments, may include the step of displaying a story creation and editing control panel on the one or more client computers (Step 500).

FIG. 6 shows an example interface using the disclosed structure and software modules that may be used to display a story creation and editing control panel on the one or more client computers (Step 500). This project management story board control panel may be used to create a story on a story board. As seen in FIG. 6, creating a story may include the steps of selecting a title and priority type (such as high, medium or low) for the story, selecting a class of service for the story type, selecting a milestone to associate the story with, selecting a team requesting the story, selecting the size of the project for the story (such as small, medium or large), selecting an owner for the story, selecting a delivery date for the story, selecting an MMF to associate the story with or any combination thereof. Note that unlike sub-stories, described in detail below, the delivery date for the story is optional. Because a sub-story may only be an expedited or fixed-date class of service story type (described in detail below), the sub-story may require a delivery date where the standard story does not.

The milestone associated with the story may be one of many milestones created by the user. A milestone may be some sort of meaningful deliverable tied back into the stories. In other words, milestones allow stories to be managed in a “bucket,” so that each story that flows through the story board may be associated with a milestone, and the associated stories may be displayed grouped within “swim lanes” or horizontal divisions on the story board for the associated milestone.

In addition to being viewed on the story board, milestones may be part of a planning board, similar in many ways to the story board, but containing two divisions. A first division may be for a backlog of stories listed in a dropdown column, each backlogged item containing the story details shown in FIG. 4 and color coded according to the story's class of service.

A second division of the planning board may be for creation and display of milestones. In this example embodiment, manager access rights may be required to create the milestone. An electronic form may be displayed and used to fill out details about the milestone. The milestone form may include a milestone name, a target date for the milestone, a description of the milestone, possibly in HTML format, an owner of the milestone and whether the milestone is visible to executives and if it is a deployment. To associate the milestone to a deployment for reporting purposes, a checkbox on the milestone form may be checked, as a non-limiting example, and one or more checkboxes for different deployment types, possibly including “Feature,” “Hardening” and “Security” may also be selected.

Once the milestone is created and associated with one or more stories, the milestone may be displayed in the milestones area of the planning board. Each milestone may be displayed with details about that milestone, similar to the story card illustrated in FIG. 6, with the distinction that the milestone details may include the number of stories associated with the milestone, the target date for the milestone, a completion percentage for the milestone, the owner of the milestone, whether the milestone is visible to executives, or possible actions to take for the milestone, such as archiving the milestone, described herein.

Once a milestone is created, it may be associated with a story on the story creation and editing control panel seen in FIG. 6. Like milestones, an MMF may also be associated to a user story using the story creation and editing control panel.

To complete a milestone, all of the stories associated with the milestone on the story board may be moved to the “complete” column for that milestone and it may be automatically completed and marked as complete on the story board, planning board and project tree. However, the stories and milestone may stay in the implementation and/or planning board view until they are archived. An archive icon in the details of the milestone on the planning board may be clicked to remove the milestone from the implementation and/or planning board.

One or more classes of service may be defined based on business impact. As seen in FIG. 6, the different classes of services may be bundled as story types and associated with each story. In this non-limiting example, the expedite and fixed date story types may be their own class of service and the feature, tech improvement, task, bug and SD change order types may all be considered “standard-class.” Each of the classes of service may be color-coded as applied to the cards on the story board, so the user may tell at a glance the class of service for any given story on the board.

The Expedite class of service is well understood in the manufacturing industry as a story with the ability to expedite offers for a vendor. A story of this type may be designed to drop everything currently being worked on to focus on this. The fixed delivery date class of service attaches a “fixed” date in order to deliver the story by the date specified. The policies and service-level agreement for a standard class item may vary by work item type. Feature, tech improvement, task, bug and SD change order classes of service are all considered standard classes of service, or part of normal work and flow. The classes of service listed here and shown in FIG. 6 are for exemplary purposes only and should not limit the scope of the current invention.

Dashboards and reports as described above and related to classes of service may be displayed within the current system. For example, a story types dashboard may display a view into what kind of stories are on a given story board that are within ready or ‘in-progress’ columns. Different portfolio mixes may be displayed such as class-of-service, story size, story priority, assigned/not assigned to an MMF etc.

A lead & cycle time report may also display class-of-service information. Lead time may indicate how predictably the organization delivers against the promises in the class-of-service definitions. For example, this report may analyze if a story was expedited, how quickly did the team get it from the order into production, if it was a standard class (ex. feature, tech improvement, etc.), if it was delivered within a target lead time, etc.

As seen in FIG. 6, once a class of service for the story type is selected for the story, the story may be assigned to a team. The team could be the team that the user belongs to, another team using the system, or a 3^{rd} party team, discussed in more detail below.

Each story may also have an owner associated with it. An option to have multiple owners may be provided, but a user can't change the owner rights of another user. Each user may be presented the option to be an owner of a story, via the card for that story on the story board, possibly by checking an owner box on the card for the appropriate story. For example, the example card displayed in FIG. 4 shows that User A is both a contributor and owner. To become an owner, User A may check the displayed checkbox to become an owner of the story.

The association of a story to an MMF may require members of the associated team to complete the association between stories and MMFs. These associations may require user rights of a user, product manager or project manager. As seen in the non-limiting example in FIG. 6, an MMF dropdown including all MMFs for the associated team may exist on the story creation and editing control panel. The MMFs in the drop down may be ordered by project date, project milestone date or MMF date. The projects and project milestones may be configured so they can't be selected, but the MMF related to the projects and project milestones may be selected.

As seen in FIG. 6, the story creation and editing control panel may also include a series of tabs. These tabs may include a description of the story, tags for the story, contributors to the story, comments about the story and a tab to add a sub-story. When the sub-stories tab is clicked on, a new sub-story window, shown in FIG. 8 may be displayed. Adding and displaying a sub-story is similar to adding and displaying an original story, but with some notable differences, described in detail below.

Once the story is created and displayed on the story board as seen in FIG. 4, each card for the story may be used to add contributors. The contributing feature may allow for multiple owners and users for a story. The system may be fully keyed by user participation, so that if a user doesn't participate, they can't contribute. The system may keep track of how long users contribute to a story, which may then be displayed in a user workload report.

To contribute, a user of the system may have two options. First, although not shown in the non-limiting example shown in FIG. 4, the user may click a contribute icon shown on the card for that project. The second way to contribute may be to drag and drop a story to another column as seen in FIG. 4. Any user who is not currently contributing to a story and drags and drops the story to another column as shown may automatically be tagged as a contributor. Further, if there is no owner of the story when the story is dragged and dropped to another column, the user may automatically be tagged as the owner. To view the information for tracking who contributed to the story and for how long, the user may select the contributors tab seen in FIGS. 6 and 8 when editing a story.

To stop contributing, a user of the system may have three options: The first way, shown in the non-limiting example embodiment in FIG. 4, may be to click on a stop contributing icon. A user may remove themselves from contributing to a story altogether by clicking on a delete contribution association icon. To help assist with more accuracy, if a user is still contributing to a story and moves it from one main column to another, such as from Development to QA as seen in FIG. 4, they may be prompted to confirm that they still want to continue contributing.

In addition to viewing details about contributors by selecting the contributors tag on the story creation interface seen in FIGS. 6 and 8, a product contributors dashboard may also be displayed to the user when they first enter the disclosed system after authentication. This dashboard may give the user a view into how contributors on their team are allocated, if individuals are over/under worked for stories that are ready or ‘in-progress’ on the story board, etc.

Once stories are created, they may be searched in-depth. A search option may be selected from a menu on the main page of the story board, which may cause an advanced search user interface to be displayed. One or more stories may be searched by story ID, product(s), text search (title or description), a story portfolio, contributors, story status, story size, story priority, story flow, story class or any combination thereof.

This advanced search may be accessible from one or more dashboards related to the user stories. As a non-limiting example, these dashboards may show one or more pie charts. These pie charts may be linked to the advanced search, so that a user may view the stories associated with each pie slice by clicking on it. This may also take the user to the advanced search page. In addition, the dashboards may include a “My Stories Dashboard” used to give a user a quick view into stories assigned to the user including ID, status, flow, title, product and completed percentage of the user's stories.

Methods and Systems for Creating a Sub-story

Several different methods may be used to provide and manage the disclosed inventions. In an example embodiment illustrated in FIG. 1, any combination of software modules used together with hardware on one or more server computers and/or client computers, described herein, may be used to create one or more sub-stories (Step 110).

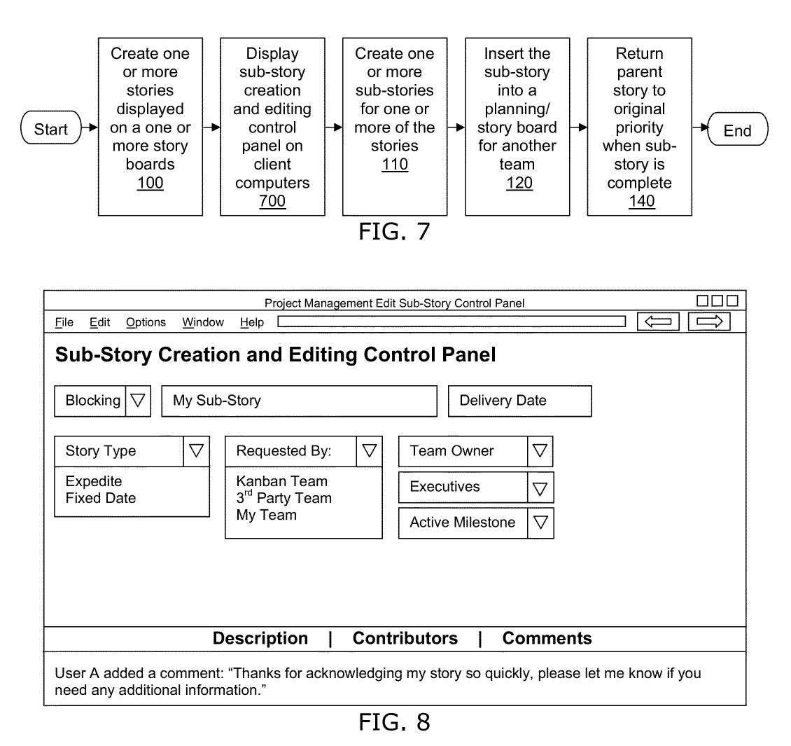

FIG. 7 shows that the embodiment illustrated in FIGS. 1-6, as well as other disclosed embodiments, may include the step of displaying a sub-story creation and editing control panel on one or more client computers for creating a sub-story (Step 700). Creating a sub-story assumes that the user of the sub-story creation and editing control panel needs the story and/or sub-story to be completed quickly.

FIG. 8 shows an example interface using the disclosed structure and software modules that may be used to display a sub-story creation and editing control panel on a one or more client computers (Step 700). In this example embodiment, when editing a story via the story creation and editing control panel shown in FIG. 6 and described in detail above, the user may have the option to create a sub-story by selecting a graphical user interface control, possibly the sub-stories tab seen in FIG. 6.

As seen in the example interface in FIG. 8, the user may select a name and priority type for the sub-story. The priority level displayed in FIG. 8 on the top left may give a user all the priority levels described herein in addition to “blocking,” discussed in more detail below. The user may use this priority interface control to either mark the story as blocking progress or simply as something needed by a date specified. Once the priority level is selected, the user may have the option to come back to this control panel and mark a story as blocking the user or story's progress later.

As seen in the non-limiting example embodiment in FIG. 8, when creating or editing a sub-story, there may be only two possible story class-of-service types for the sub-story: expedite and fixed date. The idea behind a sub-story is that the user needs this delivered soon. Expedite and fixed date classes of service may be the classes of services that will help boost the user's need for this story to be completed. Furthermore, unlike the creation of a story, where the delivery date is optional, a delivery date for a sub-story may be required, since a fixed-date or expedite class of service may used.

There may be three possible owners of a sub-story. In the example shown in FIG. 8, selection of “Kanban Team” may be a team that is currently using the disclosed system. After selecting the Kanban team option, the user may be prompted to select the team owner. Selection of “3rd Party Team” may be any selection of a team that is not currently using the system, described in more detail below. After selecting this option, the user may select the team owner for the third party team, in this example, the executive team. Non-limiting examples of other 3^{rd} party teams may include data center operations, network operations, marketing, etc. A system administrator may add these or additional 3^{rd} party teams and/or possible 3^{rd} party team owners if requested or required.

Selection of “My Team” may allow a user to add the sub-story directly to an active milestone, added according to the steps outlined above. The original creator of the sub-story or members of their team may be the only users able to edit the priority level, story name, story owner, delivery date or description in the original sub-story, possibly using an interface similar to that seen in FIG. 6 or 8.

Created sub-stories may be intended for another team using the disclosed system or a 3^{rd} party team on a 3^{rd} party board, described in detail below. As such, the creator of the sub-story may only change the owner of the sub-story or delete the sub-story if the sub-story hasn't been accepted by the original owner and has a progress percentage of 0%. Likewise, the creator of the sub-story may still delete the sub-story if 0% progress has been made. Once work has begun on the sub-story, the sub-story may no longer be deleted or the original owner changed.

The assigned owner of the sub-story and their team may be the only users who may move the story through their own board. This means that the assigned owner or their team may be the only ones to edit, possibly via an interface similar to that shown in FIG. 6, the milestone, size, initial owner, tags, contributors, sub-stories or any combination thereof related to the story. It should be noted that a sub-story may have sub-stories of its own.

During the initial creation of a sub-story, only the tab for description may be displayed (not shown). However, once the sub-story has been created, new tab options may be added to the sub-story in editing view, including tabs for contributors and adding comments, as seen in FIG. 8. These tabs may have functionality similar to the description, contributor and comments tags disclosed herein. Both the creator of the sub-story and the owners of the sub-story may add comments to the stories. These comments may be shared between story boards for different teams, as described in detail below.

A sub-story may be tracked. Once a sub-story has been created, the creator of the sub-story may track it in the sub-story section of the parent story, possibly via the sub-story tab in the parent story creation and editing control panel as seen in FIG. 6. When viewing details for the sub-story a table may be displayed including the sub-story ID, icons for options to be performed on the sub-story, the owner of the sub-story, the delivery date and a progress percentage. As the sub-story moves through the story board for the owner, the progress percentage may be reflected in this table and displayed to the creator of the sub-story.

To help visualize the sub-stories, a parent story on the creating team's planning or story board may be tagged with a color coded star, such as the star displayed on the story card in FIG. 4. For example, a green star may be displayed on the parent story indicating that the parent story has a sub-story associated with it. In one non-limiting example, if the green star is clicked, the sub-story tab within the story creation and editing control panel for that parent story may be displayed, including the table described above.

A child sub-story on the owning team's planning or story board may likewise be tagged with a different colored star, perhaps a gold star, to help visualize the sub-stories on the owner's planning or story board. As a non-limiting example, the gold star may be hover able, meaning that when a mouse is hovered over the gold star in this example, it may give the user more information about the parent story and where it came from. Once all sub-stories for a parent story are complete, the parent story may also be marked as complete. In other words, as a sub-story moves through the story boards, the progress percentage may move with it. Once the sub-story is complete, the parent story may also display its original priority status, possibly using the status indicators described herein.

Methods and Systems for Board to Board Communication

Several different methods may be used to provide and manage the disclosed inventions. In an example embodiment illustrated in FIG. 1, any combination of software modules used together with hardware on one or more server computers and/or client computers, described below, may facilitate board to board communication by displaying an alert of a sub-story on another team's planning board and requesting implementation of the sub-story into that team's story board (Step 130).

Using the sub-stories created according to the detailed description in the preceding section may give a user the option to communicate with other boards. These other boards may belong to another team using the disclosed system, or may be one or more 3rd party boards, discussed in more detail below. When a sub-story is created for another team, the purpose is to not impact the current WIP for that team. It may therefore be up to the manager of the owning team of the sub-story to prioritize and move the sub-story onto their board from their backlog, where the sub-story was posted by the creating team.

The backlog may be part of a planning board, similar in many ways to the story board, but containing two divisions: a first for a backlog of stories, possibly listed in a dropdown column with each backlogged item color coded according to the class of service and containing information such as the story card seen in FIG. 4. The planning board may also contain a milestones division for creating milestones, described above.

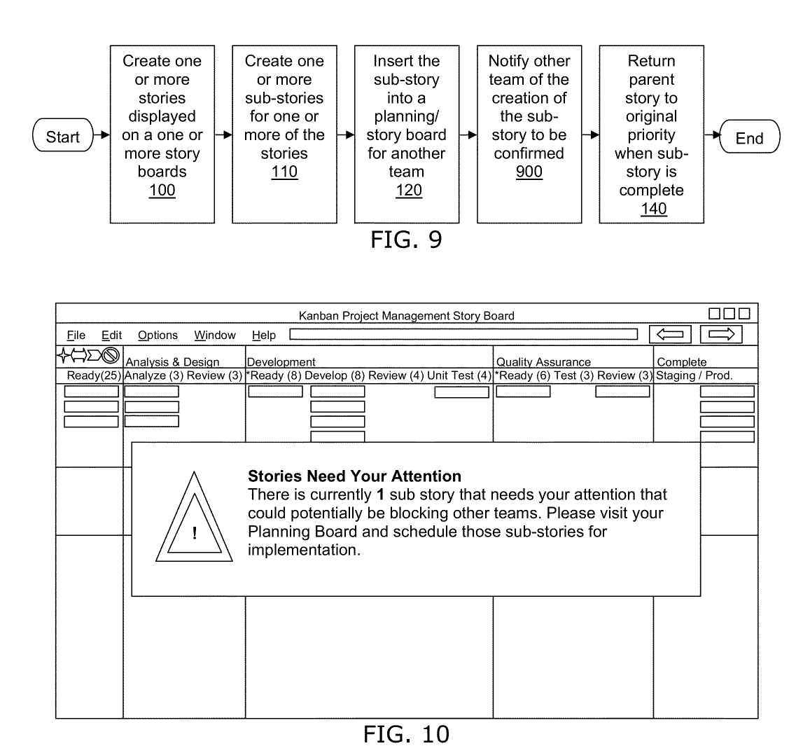

FIG. 9 shows that the embodiments illustrated in FIGS. 1-8, as well as other disclosed embodiments, may include the step of notifying another team of the creation of the sub-story for acknowledgement, confirmation, elaboration and implementation (Step 900). Notifying the owning team of creation of the sub-story is significant since their team will be affected by the creation of the sub-story by the creating team.

FIG. 10 shows an example interface using the disclosed structure and software modules that may be used to notify another team of the creation of the sub-story for confirmation, elaboration and implementation (Step 900). The system may notify the owning team of the sub-story created by the creating team by providing an alert in the story board section of the owning team. Anyone using the owning team's story board tool may see the notification of unacknowledged sub-stories for that user's team when viewing that team's story board. The stories displayed in the backlog section of the planning board may contain a gold star designating the story as a sub-story, as discussed above. This may allow the member of the owning team to quickly recognize the sub-story related to the notification within the planning board. To identify the sub-stories in the backlog section, a user need only look for the stories marked with an appropriately colored star. After identifying the sub-story, the member of the owning team may have the option to schedule the sub-stories for implementation according to the methods described herein.

FIGS. 6 and 8 shows that the embodiments illustrated herein as well as other disclosed embodiments, may include the step of sharing comments between boards. The comment section is open to all teams involved with a story or sub-story. Because the comment section is open to all teams involved with a story or sub-story, the teams involved have a means of creating communication between boards and between teams. FIGS. 6 and 8 show example interfaces using the disclosed structure that may be used to share comments between boards.

Methods and Systems for Creating a Blocking Sub-story

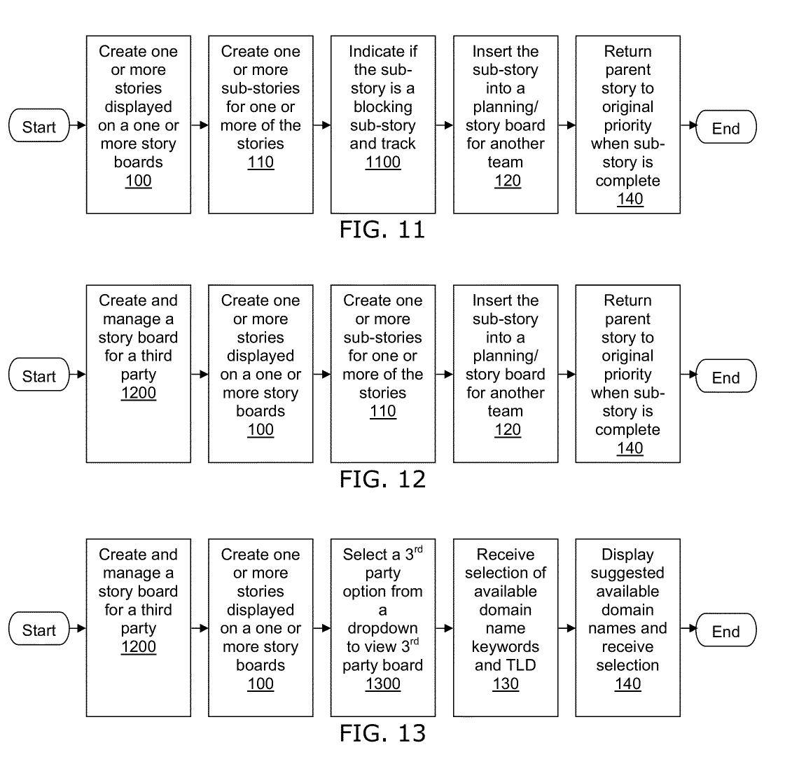

FIG. 11 shows that the embodiments illustrated in FIGS. 1-10, as well as other disclosed embodiments, may include the step of creating a sub-story and indicating if the sub-story is a blocking sub-story (Step 1100). Creating a blocking sub-story, or the use of information from blocked stories generally, is a very powerful feature introduced in conjunction with sub-stories. As seen in FIG. 8, when creating a sub-story, an option may be presented in the priority dropdown to indicate if this sub-story is blocking the creating user's team or not.

FIG. 8 shows an example interface using the disclosed structure and software modules that may be used to create a sub-story and indicate if the sub-story is a blocking sub-story (Step 1100). Indicating if a sub-story is a blocking sub-story may be included as an additional option in the priority dropdown.

FIG. 11 also shows that the embodiments illustrated in FIGS. 1-10, as well as other disclosed embodiments, may include the step of tracking a blocked sub-story. (Step 1100). The story card seen in FIG. 4 shows an example interface using the disclosed structure that may be used to track a blocked sub-story. (Step 1100). When a sub-story is created, the parent of that sub-story may immediately change from its current priority to a blocking priority. This blocking priority indication may display visualization on the story board that a story is currently blocked by another sub-story. The sub-story may also be marked with a blocking icon. The creating team may view status and track the progress of the blocked story in the sub-story section from the parent story.

As a non-limiting example, the story card displayed in FIG. 4 shows an octagon with an exclamation point that indicates a blocked story and/or a blocking sub-story. In the non-limiting example embodiment seen in FIG. 4, this section of the story card may be used to indicate the priority of the story, selected in the priority section of the story or sub-story creation interfaces seen in FIGS. 6 and 8. Once the blocking sub-story gets completed and progress is at 100%, the blocking indicator gets removed from both the sub-story and the parent story. The parent priority may be restored to its original value.

As non-limiting examples, if the parent story priority was a high priority prior to creation of the blocking sub-story, the octagon with an exclamation point on the story card seen in FIG. 4 may be replaced by a red upward arrow. The upward arrow and the red color code may indicate that the story is a high priority. Likewise, if the parent story priority was a low priority, the octagon may be replaced by a green downward arrow. The downward arrow and the green color code may indicate that the story is a low priority.

The system may keep track of the amount of time that a story is marked blocking The tracking of the amount of time a story is marked blocking may be visualized in one or more charts and/or reports for the system. For example, in a cumulative flow chart, a ‘number of stories’ flow chart and a lead and cycle time chart/report, a ‘blocked’ data set may be added to chart for all of the drill down types, including over a specified period of time and an average duration that stories are blocked over the specified period of time. This data set may show the number of blocked stories over the specified period of time to provide further insight into flow and could help explain anomalies on the chart.

Methods and Systems for Creating and Managing a 3^{rd} Party Board

Several different methods may be used to provide and manage the disclosed inventions. In an example embodiment illustrated in FIG. 12, any combination of software modules used together with hardware on one or more server computers and/or client computers, described herein, may create and manage a 3^{rd} party board (Step 100).

The 3^{rd} party board may allow a team to assign a story to another team that is currently not using the disclosed project management system. Assigning a story to a 3^{rd} party team may allow the assigning team to use all of the benefits of blocking and sub-story creation described herein. However, the creators of the sub-stories owned by 3^{rd} parties on the 3^{rd} party story board may be responsible for moving the stories and sub-stories through the 3^{rd} party board, rather than having the stories moved through the story board by the assigned owner.

The 3^{rd} party story board may include one or more 3^{rd} party teams. As previously discussed regarding FIG. 8, selection of a 3^{rd} party team may be any selection of a team that is not currently using the disclosed system. In the example embodiment shown in FIG. 8, the executive team may be the 3^{rd} party team selected. Non-limiting examples of other 3^{rd} party teams may include data center operations, network operations, marketing, etc. A system administrator may create and add additional 3^{rd} party teams if requested or required by the user creating or managing the 3^{rd} party board.

The 3^{rd} party board may follow a standard story board layout as seen in FIGS. 4 and 10 with some notable differences. The 3^{rd} party board may include a simpler layout which follows a simple ready, acknowledged, in progress, quality and complete flow. In other words, where FIG. 4 and FIG. 10 show vertical divisions in the story board for “Ready,” “Analysis & Design,” including “Analyze” and “Review,” “Development,” including “Ready” “Develop” “Review” and “Unit Test,” “Quality Assurance,” including “Ready” “Test” and “Review” and “Complete,” including “Staging” and “Production,” the 3^{rd} party story board may show major vertical divisions in the story board for “Ready,” including “Backlog” and “Acknowledged,” “In Progress,” including “In Progress” and “Quality,” and “Complete.”

In addition, where the “swim lanes” or major horizontal divisions seen in FIGS. 4 and 10 represent groupings of stories according to the milestones that consist of the grouped stories, the swim lanes on the 3^{rd} party board may represent groupings of stories associated with the 3^{rd} party teams disclosed above.

FIG. 13 shows that the embodiments illustrated in FIGS. 1-12, as well as other disclosed embodiments, may include the step of selecting a 3^{rd} party option from a dropdown list to display the board (Step 1300).

To view the 3^{rd} party board, a dropdown (not shown) may be displayed on the story board interface, such as that seen in FIGS. 4 and 10. However, this dropdown may be designed to display the story board according to various factors selected by the user. These factors may include teams, project milestones, MMFs, or milestones. If the user is not a member of the creating team for the stories/sub-stories, the user will only be able to view and not edit the stories on the 3^{rd} party story board. Only the creating team of the 3rd party owned story or sub-story may move it through the board.

The additional steps included in the embodiments illustrated in FIGS. 1-13 are not limited to their respective illustrated embodiments, and may be combined in several different orders and modified within multiple other disclosed embodiments. Likewise, the method steps disclosed herein may be accomplished by a software module executed on a server and/or client configured to accomplish that method step.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) hosting one or more server computers communicatively coupled to a network, wherein the one or more server computers comprise a project management software and wherein the project management software comprises a story board comprising one or more stories for a first team and one or more story board control panels;
b) creating a sub-story, using the one or more story board control panels, to be inserted into a second story board comprising one or more stories about, but not used by, a second team, wherein the first team is responsible for updating the one or more stories to move the one or more stories, including the sub-story, through the second story board.

2. The method of claim 1 wherein the one or more stories and the sub-story on the second story board are grouped according to the second team and one or more additional stories and sub-stories on the second story board are grouped according to one or more additional teams.

3. The method of claim 1 wherein movement through the second story board is divided according to one or more statuses for the one or more stories or the sub-story.

4. The method of claim 3 wherein the one or more statuses comprise ready, acknowledged, in progress, quality and complete.

5. The method of claim 1 wherein at least one of the one or more stories on the first story board is blocked by the sub-story implemented into the second story board.

6. The method of claim 5 wherein the sub-story on the second story board displays a blocking icon to indicate that the sub-story is blocking the at least one story.

8. The method of claim 7 wherein the at least one story displays the blocking icon to indicate that the at least one story is blocked by the sub-story.

9. The method of claim 8 wherein, responsive to completion of the sub-story, the blocking icon is removed from the story and the sub-story and the story displays a priority icon indicating a priority of the story.

10. The method of claim 1 wherein the one or more story board control panels comprise a story creation and editing control panel.

11. The method of claim 10 wherein the sub-story is created using a sub-story tab within the story creation and editing control panel.

12. The method of claim 1 wherein the one or more story board control panels comprise a sub-story creation and editing control panel.

13. The method of claim 12 further comprising the step of receiving a selection of an expedite class of service or a fixed date class of service from the sub-story creation and editing control panel.

14. The method of claim 1 wherein each of the one or more stories associated with the sub-story displays a sub-story icon.

15. The method of claim 14 wherein, responsive to clicking the sub-story icon, content for a sub-story tab, comprising details about the sub-story, is displayed on a story creation and editing control panel.

16. The method of claim 15 wherein the content for the sub-story tab comprises the owner, title, delivery date and progress of the sub-story.

17. The method of claim 1 wherein the sub-story displays a parent story icon on the second story board.

18. The method of claim 17 wherein details about the at least one story associated with the sub-story are displayed, responsive to hovering a mouse over the parent story icon, wherein the details comprise a story ID, an owner, a title, the first team requesting the sub-story and a priority.

19. The method of claim 1 wherein at least one of the one or more stories is marked complete only if the sub-story is complete.
